(19) United States
(12) Patent Application Publication
(10) Pub. No.: US 2022/0097212 A1
(43) Pub. Date: Mar. 31, 2022

(54) REVERSIBLE RATCHET WRENCH

(71) Applicant: RE-DAI PRECISION TOOLS CO.,LTD., Taichung (TW)

(72) Inventor: Yi-Chiu CHOU, Taichung (TW)

(21) Appl. No.: 17/325,359

(22) Filed: May 20, 2021

(30) Foreign Application Priority Data
Sep. 30, 2020 (TW) 109134161

(51) Int. Cl. B25B 13/46

(52) U.S. Cl. CPC B25B 13/463

(57) ABSTRACT

A reversible ratchet wrench includes a body, a ratchet wheel member rotatably disposed in the body, a pawl movably disposed in the body and engaged with the ratchet wheel member, a switch member pivotally disposed in the body about a pivotal axis, and a pushing assembly received in the switch member and abutting against the pawl. The switch member defines a front side and a rear side. The front side is provided with a bore extending in a radial direction of the pivotal axis to receive the pushing assembly. The switch member is integrally formed with a reinforcing portion protruding outwardly from the front side in the radial direction of the pivotal axis.

### BACKGROUND OF THE INVENTION

The present invention relates to a reversible ratchet wrench and, more particularly, to a reversible ratchet wrench with good durability.

Conventional reversible ratchet wrench includes a head, a ratchet wheel, a pawl, and a switch member. The ratchet wheel is rotatably arranged in the head and adapted for connecting with a work piece. The pawl is movably received in the head to be engaged with the ratchet wheel. The switch member is movably received in the body and configured to selectively actuating the pawl to engage with the ratchet wheel and to control an active direction of the ratchet wheel.

However, the switch member pivotally disposed in a cavity of the head causes a abrasion problem due to friction with an inner wall of the cavity. Furthermore, when the user drive the work piece, the force or reaction force of operating the ratchet wrench will be transmitted to the pawl and the switch member via the ratchet wheel, so that the switch member will be damaged due to excessive force. As a result, the improper reversal problem of the ratchet wrench will occur.

In view of the above, a need exists for a reversible ratchet wrench that mitigates and/or obviates the above drawbacks.

### BRIEF SUMMARY OF THE INVENTION

An objective of the present invention is to provide a reversible ratchet wrench having a durable switch member. The reversible ratchet wrench includes a body, a ratchet wheel member, a pawl, a switch member, and a pushing assembly. The body has a head. The ratchet wheel member is rotatably disposed in the head. The pawl is movably disposed in the head and engaged with the ratchet wheel member. The switch member is pivotally disposed in the head about a pivotal axis. The switch member defines a front side facing to the pawl and a rear side opposite to the front side. The front side is provided a bore extending in a radial direction of the pivotal axis. The switch member is integrally formed a reinforcing portion protruding outwardly from the front side in the radial direction of the pivotal axis. The pushing assembly is received in the bore of the switch member and abuts against the pawl.

In an example, the head is provided with a first compartment penetrating through two opposite sides thereof, a second compartment communicating with the first compartment, a third compartment extending along the pivotal axis and penetrating through one side thereof, and a fourth compartment communicating with the second and third compartments. The ratchet wheel member is rotatably disposed in the first compartment. The pawl is movably disposed in the second compartment. The switch member is pivotally disposed in the third compartment about the pivotal axis. The reinforcing portion selectively abuts against an internal face of the fourth compartment as the switch member pivots relative to the head.

In an example, the pushing assembly includes a pusher movably received in the bore in the radial direction of the pivotal axis, and a first elastic member biasing the pusher radially outward from the bore. The pusher has a first end protruding outwardly from the bore to abut against the pawl, and a second end abutted against the first elastic member. A first length is defined between the reinforcing portion and an external face of the front side of the switch member. A second length is defined between the first end of the pusher and the external face of the front side of the switch member. The second length is permanently greater than the first length.

In an example, the bore is recessed on the front side of the switch member and does not penetrate the rear side of the switch member. One end of the first elastic member opposite to the pusher abuts against a bottom face of the bore.

In an example, the head is further provided with a fifth compartment communicating with the third compartment. The rear side of the switch member is provided with two positioning recesses and two rib portions adjacent to the two positioning recesses. The two rib portions abut against an internal face of the third compartment. The reversible ratchet wrench further includes a positioning assembly disposed in the fifth compartment. The positioning assembly includes a positioner and a second elastic member biasing the positioner outward from the fifth compartment. The positioner detachably engages with one of the two positioning recesses as the switch member pivots relative to the head.

In an example, the first elastic member is a non-circular cross-section compression spring, and the second elastic member is a circular cross-section compression spring.

In an example, the body includes a cover detachably connected to the head. The cover has a hole for the ratchet wheel member to penetrate. The switch member has a top side exposed from the third compartment along the pivotal axis, and a bottom side abutted against the cover.

The present invention will become clearer in light of the following detailed description of illustrative embodiments of this invention described in connection with the drawings.

### DESCRIPTION OF THE DRAWINGS

FIG. 1 is a perspective view of a reversible ratchet wrench of an embodiment according to the present invention.

FIG. 2 is an exploded, perspective views of the reversible ratchet wrench of FIG. 1.

FIGS. 3 and 4 are cross-sectioned views of the reversible ratchet wrench of FIG. 1.

### DETAILED DESCRIPTION OF THE INVENTION

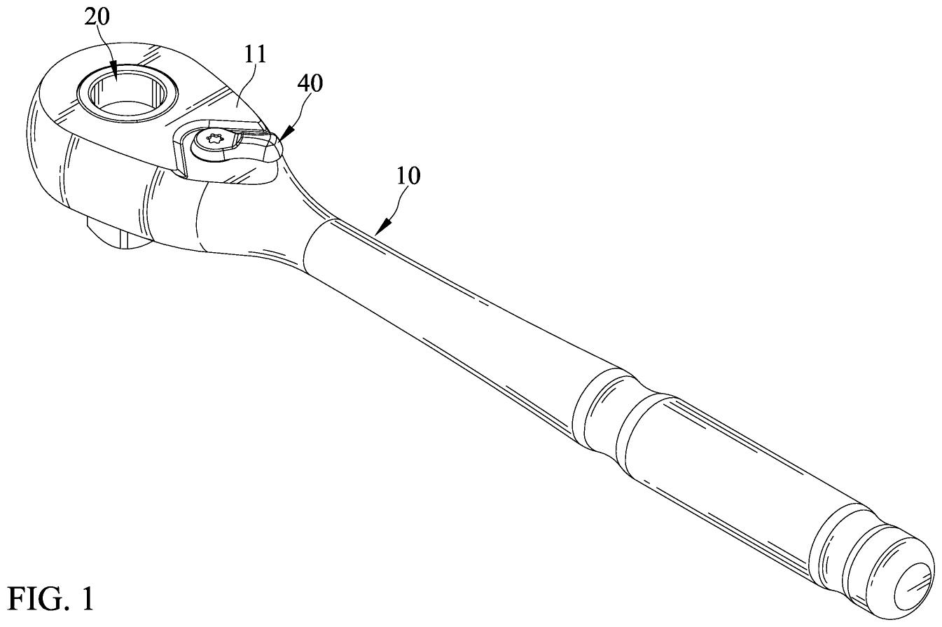

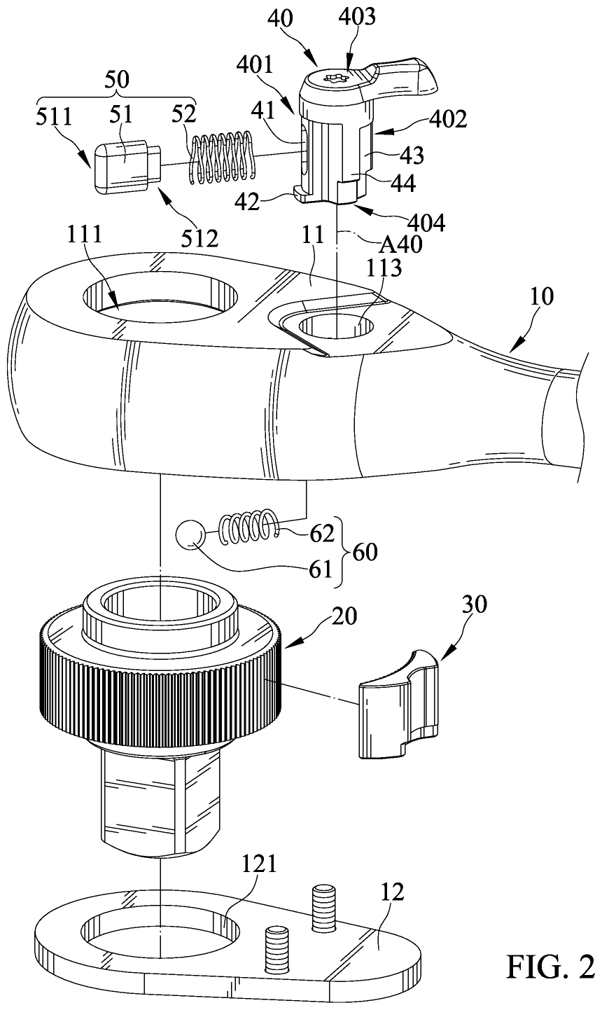

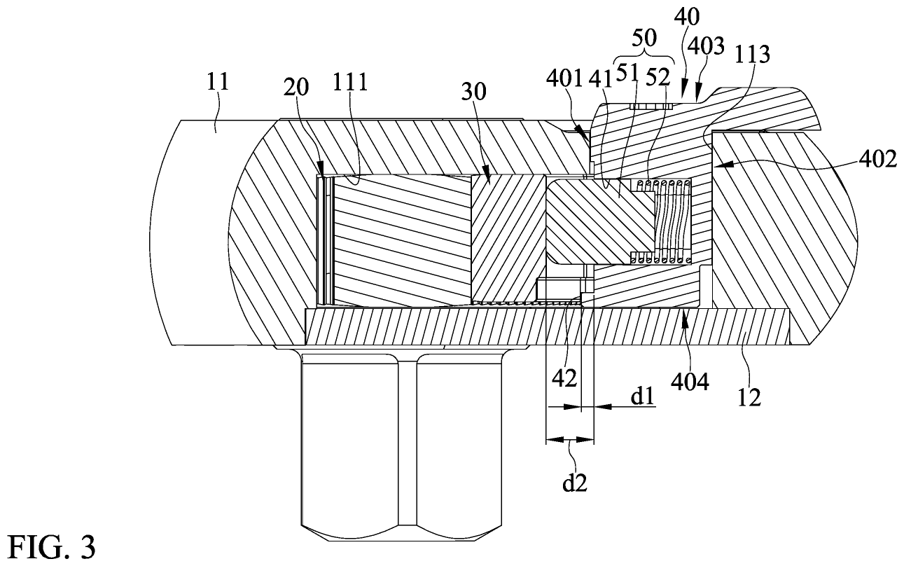

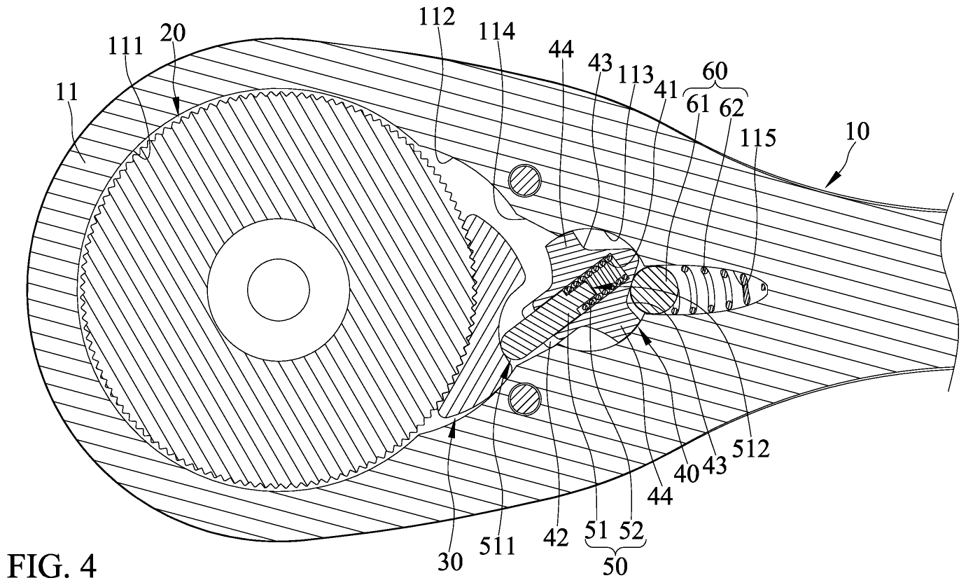

With reference to FIGS. 1-4, a reversible ratchet wrench of an embodiment according to the present invention includes a body 10, a ratchet wheel member 20, a pawl 30, a switch member 40, and a pushing assembly 50. The body 10 has an elongated handle and a head 11 extending from the handle. The ratchet wheel member 20 is rotatably disposed in the head 11. The pawl 30 is movably disposed in the head 11 and engaged with the ratchet wheel member 20. The switch member 40 is pivotally disposed in the head 11 about a pivotal axis A40. The switch member 40 defines a front side 401 facing to the pawl 30 and a rear side 402 opposite to the front side 401. The front side 401 is provided a bore 41 extending in a radial direction of the pivotal axis A40. and the switch member 40 is integrally formed a reinforcing portion 42 protruding outwardly from the front side 401 in the radial direction of the pivotal axis A40. The pushing assembly 50 is received in the bore 41 of the switch member 40 and abutting against the pawl 30. Therefore, the structural strength of the switch member 40 is improved by the reinforcing portion 42 to provide a reversing ratchet wrench with good durability.

Further, the head 11 is provided with a first compartment 111 penetrating through two opposite sides thereof, a second compartment 112 communicating with the first compartment 111, a third compartment 113 extending along the pivotal axis A40 and penetrating through one side thereof, and a fourth compartment 114 communicating with the second and third compartments 112 and 113. The ratchet wheel member 20 is rotatably disposed in the first compartment 111. The pawl 30 is movably disposed in the second compartment 112 so that the pawl 30 is movable laterally with respect to the ratchet wheel member 20 between a first position in which the pawl 30 is disposed between the body 10 and the ratchet wheel member 20 so that the body 10 transmits torque through the pawl 30 in a first rotational direction, and a second position in which the pawl 30 is disposed between the body 10 and the ratchet wheel member 20 so that the body 10 transmits torque through the pawl 30 in an opposite rotational direction. The switch member 40 is pivotally disposed in the third compartment 113 about the pivotal axis A40. The reinforcing portion 42 selectively abuts against an internal face of the fourth compartment 114 as the switch member 40 pivots relative to the head 11.

When the user uses the reversible ratchet wrench to turn an object, the force or reaction force of operating the ratchet wrench will applied to the pawl 30, the switch member 40, and the pushing assembly 50 via the ratchet member 20. The reinforcing portion 42 abuts against the internal face of the fourth compartment 114, so that part of the force or reaction force can be transmitted to the head 11 of the body 10, so as to prevent the switch member 40 damaged due to excessive force to increase the service life of the reversible ratchet wrench.

The pushing assembly 50 of this embodiment may include a pusher 51 movably received in the bore 41 in the radial direction of the pivotal axis A40, and a first elastic member 52 biasing the pusher 51 radially outward from the bore 41. The pusher 51 has a first end 511 protruding outwardly from the bore 41 to abut against the pawl 30, and a second end 512 abutted against the first elastic member 52. A first length d1 is defined between the reinforcing portion 42 and an external face of the front side 401 of the switch member 40, and a second length d2 is defined between the first end 511 of the pusher 51 and the external face of the front side 401 of the switch member 40. The second length d2 is permanently greater than the first length d1. In other words, no matter where the pusher 51 moves relative to the bore 41 in the radial direction of the pivotal axis A40, the second length d2 is always greater than the first length d1, that is, the first end 511 of the pusher 51 always protrude further than the reinforcing portion 42.

In addition, the bore 41 may be recessed on the front side 401 of the switch member 40 and does not penetrate the rear side 402 of the switch member 40. One end of the first elastic member 52 opposite to the pusher 51 abuts against a bottom face of the bore 41.

Furthermore, the head 11 is further provided with a fifth compartment 115 communicating with the third compartment 113. The rear side 402 of the switch member 40 is provided with two positioning recesses 43 and two rib portions 44 adjacent to the two positioning recesses 43. The two rib portions 44 abut against an internal face of the third compartment 113.

The reversible ratchet wrench may further include a positioning assembly 60 disposed in the fifth compartment 115. The positioning assembly 60 may include a positioner 61 and a second elastic member 62 biasing the positioner 61 outward from the fifth compartment 115. Thus, the positioner 61 can detachably engage with one of the two positioning recesses 43 as the switch member 40 pivots relative to the head 11 to prevent the switch member 40 from pivoting relative to the head 11 unintentionally.

In addition, the first elastic member 52 of this embodiment may be a non-circular cross-section compression spring, and the second elastic member 62 may be a circular cross-section compression spring.

The body 10 may further include a cover 12 detachably connected to the head 11. The cover 12 has a hole 121 for the ratchet wheel member 20 to penetrate. The switch member 40 has a top side 403 exposed from the third compartment 113 along the pivotal axis A40, and a bottom side 404 abutted against the cover 12. Therefore, the cover 12 can prevent the ratchet wheel member 20, the pawl 30, and the switch member 40 from being detached from the head 11.

In summary, the reversible ratchet wrench of this embodiment improves the structural strength of the switch member 40 by the reinforcing portion 42, and the reinforcing portion 42 can abut against the internal face of the fourth compartment 114, so that part of the force or reaction force can be transmitted to the head 11 of the body 10, so as to prevent the switch member 40 damaged due to excessive force to increase the service life of the reversible ratchet wrench.

Although specific embodiments have been illustrated and described, numerous modifications and variations are still possible without departing from the scope of the invention. The scope of the invention is limited by the accompanying claims.

1. A reversible ratchet wrench comprising:
a body having a head;
a ratchet wheel member rotatably disposed in the head;
a pawl movably disposed in the head and engaged with the ratchet wheel member;
a switch member pivotally disposed in the head about a pivotal axis, wherein the switch member defines a front side facing to the pawl and a rear side opposite to the front side, wherein the front side is provided a bore extending in a radial direction of the pivotal axis, and wherein the switch member is integrally formed a reinforcing portion protruding outwardly from the front side in the radial direction of the pivotal axis, and wherein the reinforcing portion has a side face coplanar with a side face of the front side of the switch member; and
a pushing assembly received in the bore of the switch member and abutting against the pawl.

2. The reversible ratchet wrench as claimed in claim 1, wherein the head is provided with a first compartment penetrating through two opposite sides thereof, a second compartment communicating with the first compartment, a third compartment extending along the pivotal axis and penetrating through one side thereof, and a fourth compartment communicating with the second and third compartments, wherein the ratchet wheel member is rotatably disposed in the first compartment, wherein the pawl is movably disposed in the second compartment, wherein the switch member is pivotally disposed in the third compartment about the pivotal axis, and wherein the reinforcing portion selectively abuts against an internal face of the fourth compartment as the switch member pivots relative to the head.

3. The reversible ratchet wrench as claimed in claim 2, wherein the pushing assembly includes a pusher movably received in the bore in the radial direction of the pivotal axis, and a first elastic member biasing the pusher radially outward from the bore, wherein the pusher has a first end protruding outwardly from the bore to abut against the pawl, and a second end abutted against the first elastic member, wherein a first length is defined between the reinforcing portion and an external face of the front side of the switch member, wherein a second length is defined between the first end of the pusher and the external face of the front side of the switch member, and wherein the second length is permanently greater than the first length.

4. The reversible ratchet wrench as claimed in claim 3, wherein the bore is recessed on the front side of the switch member and does not penetrate the rear side of the switch member, and wherein one end of the first elastic member opposite to the pusher abuts against a bottom face of the bore.

5. The reversible ratchet wrench as claimed in claim 3, wherein the head is further provided with a fifth compartment communicating with the third compartment, wherein the rear side of the switch member is provided with two positioning recesses and two rib portions adjacent to the two positioning recesses, wherein the two rib portions abut against an internal face of the third compartment, wherein the reversible ratchet wrench further comprises:
a positioning assembly disposed in the fifth compartment and including a positioner and a second elastic member biasing the positioner outward from the fifth compartment, and wherein the positioner detachably engages with one of the two positioning recesses as the switch member pivots relative to the head.

6. The reversible ratchet wrench as claimed in claim 5, wherein the first elastic member is a non-circular cross-section compression spring, and wherein the second elastic member is a circular cross-section compression spring.

7. The reversible ratchet wrench as claimed in claim 5, wherein the body includes a cover detachably connected to the head, wherein the cover has a hole for the ratchet wheel member to penetrate, and wherein the switch member has a top side exposed from the third compartment along the pivotal axis, and a bottom side abutted against the cover.
